(19) United States
(12) Patent Application Publication
(10) Pub. No.: US 2021/0062778 A1
(43) Pub. Date: Mar. 4, 2021

(54) CYCLIC HYDROPOWER SYSTEM

(71) Applicant: Che-Hsiang Wu, Tainan City (TW)

(72) Inventor: Che-Hsiang Wu, Tainan City (TW)

(21) Appl. No.: 16/997,948

(22) Filed: Aug. 20, 2020

(30) Foreign Application Priority Data
Aug. 29, 2019 (TW) 108211477

(51) Int. Cl. F03B 13/08; F03B 13/06; H02K 11/00; H02K 7/18

(52) U.S. Cl. CPC F03B 13/08; H02K 7/1823; H02K 11/0094; F03B 13/06

(57) ABSTRACT

The cyclic hydropower system includes a power generation device. The first power generation device includes a circular frame pivoted on an axle whose one end is coupled to an end of the axle. A number of basins are arranged around the circular frame. An arc trough is positioned at a distance from and along an arc section of the circular frame. A channel is formed between the arc trough and the circular frame allowing the basins to move through. The channel has inlet at an upper position and an outlet at a lower position. A tank is positioned beneath the outlet of the power generation device, a pumping element is provided inside the tank, and a pipe extended from the pumping element above the power generation device with a pipe outlet above the inlet of the power generation device.

### BACKGROUND OF THE INVENTION

### (a) Technical Field of the Invention

The present invention is generally related to hydropower systems, and more particular to a cyclic hydropower system.

### (b) Description of the Prior Art

As shown in FIG. 1, a conventional hydropower system is to have a dam 10 to hold water A0 in a higher place, and the water A0 is drawn to drive the power equipment 20 beneath the dam 10.

Building the dam 10 in a higher ground to hold a massive amount of water A0 is costly, and the power equipment 20 is also expensive. Such a high cost is not affordable to ordinary people or small communities. The dam 10 also has to be built in a catchment of water A0.

### SUMMARY OF THE INVENTION

Therefore, a novel hydropower system is provided herein.

The hydropower system includes a first power generation device, a control element, an electricity storage element, and a pumping member. The first power generation device includes an axle, a circular frame pivoted on the axle, a power generation element coupled to an end of the axle, two sets of spokes extended from the axle respectively to a first rim and a second rim of the circular frame, a number of basins arranged at equal intervals around a circumferential side of the circular frame, each between pairs of neighboring spokes, a number of circumferential weight, each mounted on the circular frame beneath each basin, and an arc trough positioned at a distance from and along an arc section of the circular frame. A channel is formed between the arc trough and the circular frame allowing the basins to move through. The channel has inlet at an upper position and an outlet at a lower position. The power generation element is connected to the control element and, through the control element, connected to the electricity storage element. The pumping member includes a tank positioned beneath the outlet of the first power generation device, a pumping element provided inside the tank and connected to the control element, a pipe extended from the pumping element above the first power generation device with a pipe outlet above the inlet of the first power generation device. Each basin includes a chamber having an open side, and the chamber is indented from the open side towards a rotational direction of the circular frame. Each spoke has a spoke weight arranged around an outer section of the spoke adjacent to the first or second rim of the circular frame. Each spoke weight includes a space with an opening connecting the space; and the opening is sealed by a cap.

In an alternative embodiment, the hydropower system further comprises a second power generation device as claimed above positioned above the first power generation device. The second power generation device has its outlet above the inlet of the first power generation device. The pipe is extended from the pumping element above the second power generation device, and the pipe outlet of the pipe is above the inlet of the second power generation device.

In an alternative embodiment, the hydropower system further comprises a second power generation device as claimed above and a second tank beneath the outlet of the second power generation device and above the first power generation device. The second tank has a tank outlet on a bottom side above the inlet of the first power generation device. The pipe is extended from the pumping element above the second power generation device, and the pipe outlet of the pipe is above the inlet of the second power generation device.

A major feature of the present invention lies in the adoption of a circular frame with basins arranged around the circumference and an arc trough covering an arc section of the circumference. Then, by filling water into the arc trough to weight the basins down and, as such, to pull the circular frame to spin, electricity is thereby produced. In this way, the significant cost for hydropower generation is obviated.

Another feature of the present invention lies in the use of a pumping element to recycle the water and, as such, a number of power generation devices may be cascaded at descending heights so that the water recycled by the pumping element may be applied to sequentially drive these power generation devices and to produce electricity of multiple times to that from a single power generation device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional hydropower system.

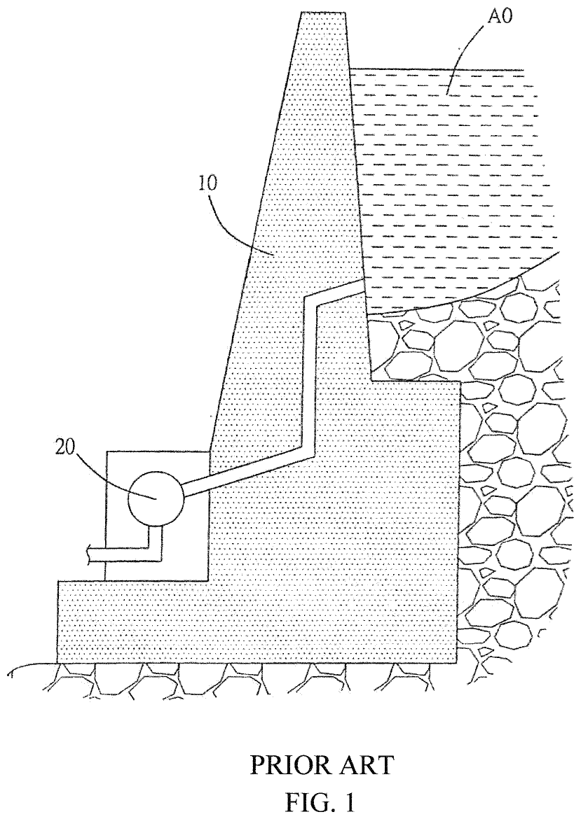

FIG. 2 is a schematic profile diagram showing a hydropower system according to an embodiment of the present invention.

FIG. 3 is a schematic sectional diagram showing the hydropower system of FIG. 2.

FIG. 4 is a schematic profile diagram showing a hydropower system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

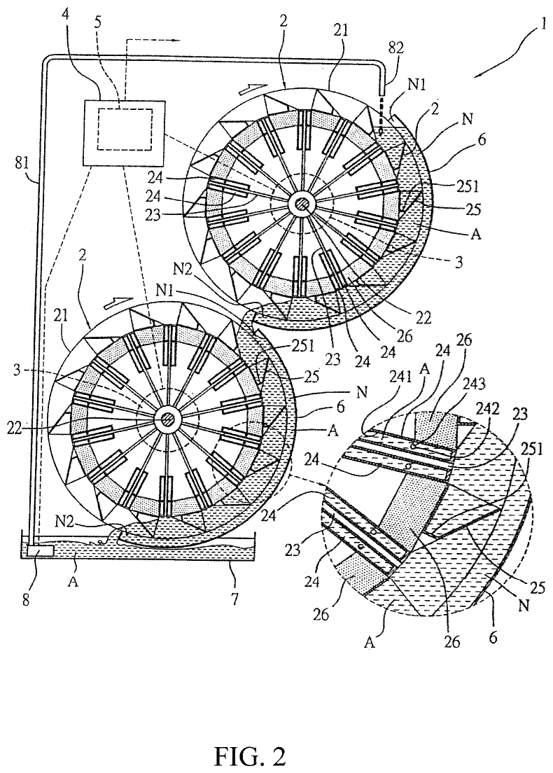

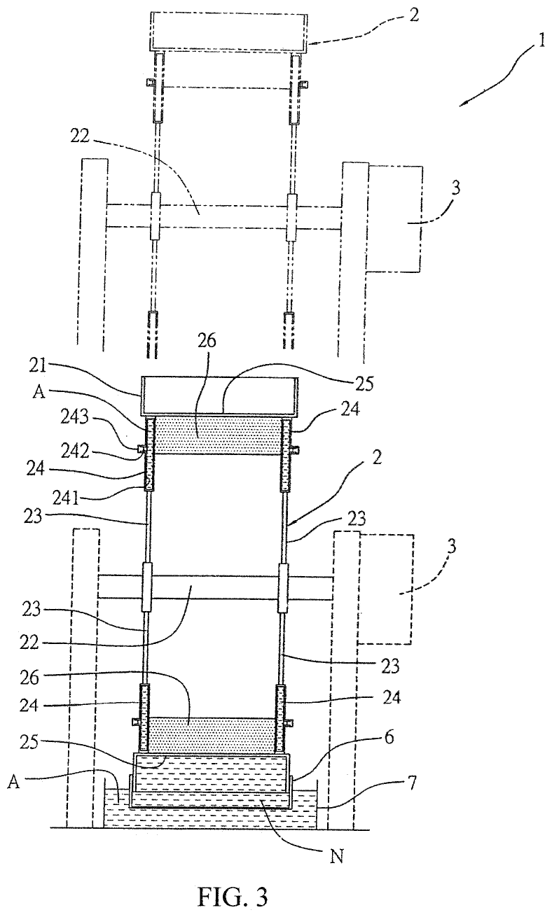

As shown in FIGS. 2 and 3, a hydropower system 1 according to an embodiment of the present invention includes at least two power generation devices 2 sequentially arranged in descending heights. A lower power generation device 2 has at least another power generation device 2 positioned above the lower one. Each power generation device 2 includes a circular frame 21 pivoted on an axle 22. The axle 22 is rotatably mounted on a rack and has an end coupled to a power generation element 3. The power generation element 3 is connected to a control element 4 and, through the control element 4, connected to an electricity storage element 5. Two sets of spokes 23 are extended from the axle 22 respectively to a first rim and a second rim of the circular frame 21. Each spoke 23 has a spoke weight 24 arranged around an outer section of the spoke 23 adjacent to the first or second rim of the circular frame 21. A number of basins 25 are arranged at equal intervals around a circumferential side of the circular frame 21, each between pairs of neighboring spokes 23. Beneath each basin 25, a circumferential weight 26 is mounted on the circular frame 21. An arc trough 6 is positioned at a distance from and roughly between a two o'clock position and a seven o'clock position of the circular frame 21. The distance between the arc trough 6 and the circular frame 21 forms a channel N allowing the basins 25 to move through. The channel N has inlet N1 roughly at the two o'clock position of the circular frame 21 and an outlet N2 roughly at the seven o'clock position. A higher positioned power generation device 2 has its outlet N2 right above the inlet N1 of a lower-positioned power generation device 2. For the lowest positioned power generation device 2, a tank 7 is positioned beneath its outlet N2. Inside the tank 7, a pumping element 8 is provided and connected to the control element 4. A pipe 81 is extended from the pumping element 8 above the highest positioned power generation device 2 and, as shown in FIG. 2, a pipe outlet 82 of the pipe 81 is right above the inlet N1 of the highest positioned power generation device 2.

Each basin 25 includes a chamber 251 having an open side and the chamber 251 is indented towards the rotational direction of the circular frame 21. Water A stored in the tank 7 and pumped by the pumping element 8 into the pipe 81 flows out of the pipe outlet 82 into the inlet N1 of the highest-positioned power generation device 2. Water A then flows through the channel N of the highest-positioned power generation device 2, out of the outlet N2 into the channel N of an neighboring and lower-positioned the power generation device 2. The process then repeats until water A enters the tank 7 beneath the lowest-positioned power generation device 2. Water A is again pumped by the pumping element 8 and therefore utilized in a cyclic manner. As water A flows through the channels N of the power generation devices 2, it pushes the basins 25 within the channels, thereby spinning the axle 22 and driving the power generation element 3 to produce electricity. The electricity from the power generation element 3 is stored in the electricity storage element 5 and then rectified and output by the control element 4, or directly rectified and output by the control element 4 for consumption. The electricity stored in the electricity storage element 5 may be continuously and partially distributed through the control element 4 to power the pumping element 8. A single pumping element 8 then may drive multiple power generation devices 2, thereby producing electricity that is multiple times to that of a single power generation device 2, as shown in FIG. 2.

Each spoke weight 24 may include a space 241 with an opening 242 connecting the space 241 which may be sealed by a cap 243. The space 241 may be filled with water A whose weight increases the rotational momentum of the circular frame 21 contributed by the circumferential weights 26, as shown in FIGS. 2 and 3.

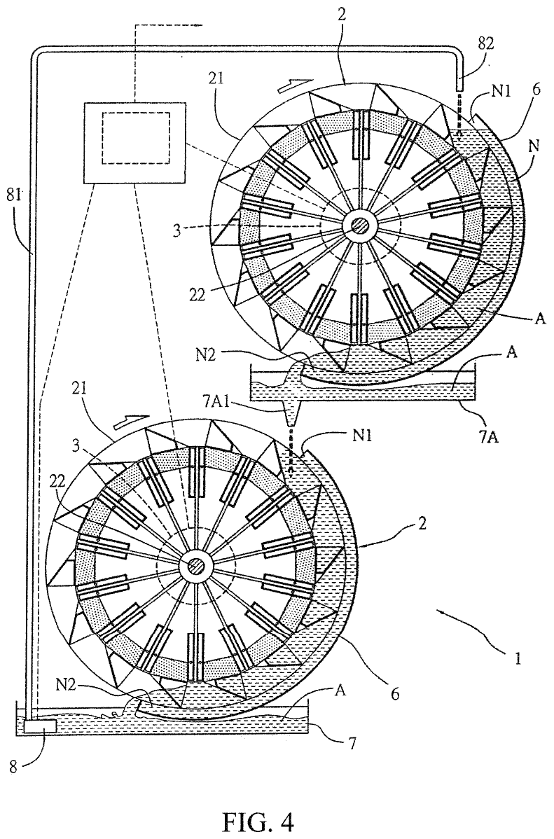

As shown in FIG. 4, another embodiment of the present invention has a second tank 7A beneath the outlet N2 of each power generation device 2 above the lowest-positioned the power generation device 2. Each second tank 7A has a tank outlet 7A1 on a bottom side aiming at the inlet N1 of a neighboring, lower-positioned power generation device 2.

As described above, the cyclic hydropower system 1 continuously pumps water A by the pumping element 8 to above the highest-positioned power generation device 2. Water A then sequentially drives a number of power generation devices 2 arranged in descending heights. The electricity storage element 5, through the control element 4, continuously and partially distributes its electricity to power the pumping element 8 so that a single pumping element 8 may continuously operate multiple the power generation devices 2 and output electricity of multiple times.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A hydropower system, comprising a first power generation device, a control element, an electricity storage element, and a pumping member, wherein
the first power generation device comprises an axle, a circular frame pivoted on the axle, a power generation element coupled to an end of the axle, two sets of spokes extended from the axle respectively to a first rim and a second rim of the circular frame, a plurality of basins arranged at equal intervals around a circumferential side of the circular frame, each between pairs of neighboring spokes, a plurality of circumferential weight, each mounted on the circular frame beneath each basin, and an arc trough positioned at a distance from and along an arc section of the circular frame;
a channel is formed between the arc trough and the circular frame allowing the basins to move through;
the channel has inlet at an upper position and an outlet at a lower position;
the power generation element is connected to the control element and, through the control element, connected to the electricity storage element;
the pumping member comprises a tank positioned beneath the outlet of the first power generation device, a pumping element provided inside the tank and connected to the control element, a pipe extended from the pumping element above the first power generation device with a pipe outlet above the inlet of the first power generation device.

2. The hydropower system according to claim 1, wherein each basin comprises a chamber having an open side; and the chamber is indented from the open side towards a rotational direction of the circular frame.

3. The hydropower system according to claim 1, wherein each spoke has a spoke weight arranged around an outer section of the spoke adjacent to the first or second rim of the circular frame; each spoke weight comprises a space with an opening connecting the space; and the opening is sealed by a cap.

4. The hydropower system according to claim 1, further comprising a second power generation device as claimed in claim 1 positioned above the first power generation device, wherein the second power generation device has its outlet above the inlet of the first power generation device; the pipe is extended from the pumping element above the second power generation device; and the pipe outlet of the pipe is above the inlet of the second power generation device.

5. The hydropower system according to claim 2, further comprising a second power generation device as claimed in claim 1 positioned above the first power generation device, wherein the second power generation device has its outlet above the inlet of the first power generation device; the pipe is extended from the pumping element above the second power generation device; and the pipe outlet of the pipe is above the inlet of the second power generation device.

6. The hydropower system according to claim 3, further comprising a second power generation device as claimed in claim 1 positioned above the first power generation device, wherein the second power generation device has its outlet above the inlet of the first power generation device; the pipe is extended from the pumping element above the second power generation device; and the pipe outlet of the pipe is above the inlet of the second power generation device.

7. The hydropower system according to claim 1, further comprising a second power generation device as claimed in claim 1 and a second tank beneath the outlet of the second power generation device and above the first power generation device; wherein the second tank has a tank outlet on a bottom side above the inlet of the first power generation device; the pipe is extended from the pumping element above the second power generation device; and the pipe outlet of the pipe is above the inlet of the second power generation device.

8. The hydropower system according to claim 2, further comprising a second power generation device as claimed in claim 1 and a second tank beneath the outlet of the second power generation device and above the first power generation device; wherein the second tank has a tank outlet on a bottom side above the inlet of the first power generation device; the pipe is extended from the pumping element above the second power generation device; and the pipe outlet of the pipe is above the inlet of the second power generation device.

9. The hydropower system according to claim 3, further comprising a second power generation device as claimed in claim 1 and a second tank beneath the outlet of the second power generation device and above the first power generation device; wherein the second tank has a tank outlet on a bottom side above the inlet of the first power generation device; the pipe is extended from the pumping element above the second power generation device; and the pipe outlet of the pipe is above the inlet of the second power generation device.
